(19) United States
(12) Patent Application Publication
(10) Pub. No.: US 2014/0165913 A1
(43) Pub. Date: Jun. 19, 2014

(54) DEPOSITION SOURCE AND DEPOSITION APPARATUS INCLUDING THE SAME

(71) Applicant: SAMSUNG DISPLAY CO., LTD., Yongin-City (KR)

(72) Inventor: Young Mook Choi, Yongin-City (KR)

(73) Assignee: SAMSUNG DISPLAY CO., LTD., Yongin-City (KR)

(21) Appl. No.: 13/794,627

(22) Filed: Mar. 11, 2013

(30) Foreign Application Priority Data
Dec. 17, 2012 (KR) 10-2012-0147490

(51) Int. Cl. B05D 3/02

(52) U.S. Cl. CPC B05D 3/0254
USPC 118/724

(57) ABSTRACT

A deposition source includes a furnace extending in a first direction and configured to discharge deposits on a substrate, and a cooling housing on the furnace comprising a plurality of cooling plates, wherein each of the cooling plates comprises a plurality of cooling flow paths around the furnace.

### CROSS-REFERENCE TO RELATED APPLICATION

This application claims priority to and the benefit of Korean Patent Application No. 10-2012-0147490, filed on Dec. 17, 2012 in the Korean Intellectual Property Office, the disclosure of which is incorporated herein in its entirety by reference.

### BACKGROUND

1. Field

Embodiments of the present invention relate to a deposition source and a deposition apparatus including the same.

2. Description of the Related Art

A deposition process is typically included in a process of manufacturing a display device, semiconductor, and solar cells. For example, a plurality of thin films included in a liquid crystal display, a field emission display, a plasma display, and an electroluminescence display may be formed through a deposition process.

Among various kinds of deposition processes, a vapor deposition process that forms a thin film on a substrate through evaporation of deposits is performed in a deposition chamber in a vacuum state by a thermal evaporation process. That is, a substrate is positioned in a deposition chamber in a vacuum state, a deposition source is positioned opposite to one surface of the substrate, and deposits contained in a furnace of the deposition source are heated at about 300° C. to 450° C. to be evaporated. Accordingly, the deposits in a gas state come in contact with the substrate in the vacuum to be solidified, and through such a process, a thin film is formed on the substrate.

Recently, due to the large scale of the substrate, in the case of forming the thin film on the substrate in the above-described vapor deposition process, a method has been used to discharge deposits onto the substrate while the deposition source that is formed to extend in one direction moves in a perpendicular direction, parallel to the plane of the substrate. Here, the deposition source can be formed to extend corresponding to the length of a short side or a long side of the substrate, and thus the length of the deposition source may be increased as the size of the substrate is increased. If the length of the deposition source is increased as described above, a temperature deviation depending on the positions in the deposition source may occur due to the causes of heater uniformity and thermal expansion. Such a temperature deviation may cause a deviation of evaporation speed of the deposits depending on the positions in the deposition source, and a thin film with non-uniform thickness may be formed on the substrate. Such a non-uniform thin film may cause deterioration of the characteristics of the final product or inferiority of the final product.

### SUMMARY

A substantially uniform temperature of the deposition source can be maintained by positioning a cooling housing on a furnace of the deposition source and cooling portions of the deposition source at different rates depending on their location. For example, the cooling housing may include a cooling flow path, and cooling fluid may flow inside of the cooling flow path to cool the furnace. Because the cooling fluid that is input to the cooling flow path absorbs heat from the furnace as it flows through the cooling flow path, the temperature of the cooling fluid at a discharge port of the cooling flow path becomes higher than the temperature of the cooling fluid at a supply port of the cooling flow path. Because such a temperature difference of the cooling fluid may cause temperature variations at various locations or positions within the deposition source, it may be desirable to control the number of cooling flow paths and the shape or pattern of the paths themselves. Further, because the cooling efficiency of the cooling housing may differ depending on the flow rate of the cooling fluid that flows through the cooling flow path, it may also be necessary to control the flow rate of the cooling fluid.

Accordingly, exemplary embodiments of the present invention provide a deposition source which can maintain a uniform temperature of a deposition source by controlling the number of cooling flow paths, the shape or pattern of the cooling flow paths included in the cooling housing formed on the furnace, and the flow rate of the cooling fluid passing through the cooling flow paths.

Additional aspects, subjects, and features of the embodiments of the present invention will be set forth in part in the description which follows and in part will become apparent to those having ordinary skill in the art upon examination of the following or may be learned from practice of the invention.

According to an aspect of an embodiment of the present invention, there is provided a deposition source including a furnace extending in a first direction and configured to discharge deposits on a substrate, and a cooling housing on the furnace including a plurality of cooling plates, wherein each of the cooling plates includes a plurality of cooling flow paths around the furnace.

Cooling fluid may be supplied from opposing ends of each of the cooling plates through the cooling flow paths, and the cooling fluid may be discharged from a center portion of each of the cooling plates.

Each of the cooling flow paths may include a supply port configured to supply the cooling fluid and a discharge port configured to discharge the cooling fluid.

Each of the cooling flow paths may include a plurality of discharge ports corresponding to a supply port, and flow controllers coupled to the discharge ports, respectively, to control a flow rate of the cooling fluid, or may include a plurality of supply ports corresponding to a discharge port, and flow controllers coupled to the supply ports, respectively, to control the flow rate of the cooling fluid.

The furnace may include a plurality of discharge ports arranged along the first direction, and the cooling housing may be on sides of the furnace with the plurality of discharge ports exposed.

The cooling fluid may flow through the cooling flow paths, and a flow controller may be coupled to each of the cooling flow paths to control a flow rate of the cooling fluid.

The deposition source may further include a temperature sensor configured to measure a temperature of the furnace; and a controller configured to control the flow controller based on a difference between the temperature of the furnace and a preset temperature.

The controller may include a temperature storage unit configured to store the preset temperature; a temperature comparison unit configured to calculate the difference between the temperature of the furnace and the preset temperature; and a temperature compensation unit configured to increase or decrease the flow rate of the cooling fluid through the flow controller based on the difference between the temperature of the furnace and the preset temperature.

According to another aspect of an embodiment of the present invention, there is provided a deposition source including a furnace extending in a first direction and configured to discharge deposits on a substrate, and a cooling housing on the furnace including a plurality of cooling plates, wherein each of the cooling plates includes a plurality of cooling flow paths through which cooling fluid flows, and at least one flow controller coupled to each of the cooling flow paths to control a flow rate of the cooling fluid.

Each of the cooling flow paths may be around the furnace.

The cooling fluid may be supplied from opposing ends of each of the cooling plates through the cooling flow paths, and the cooling fluid may be discharged from a center portion of each of the cooling plates.

The plurality of cooling flow paths may include a plurality of first cooling flow paths spaced apart from one another and second cooling flow paths adjacent to the respective first cooling flow paths, and the cooling fluid may flow in substantially opposite directions through the first and second cooling flow paths, respectively.

The deposition source may further include a temperature sensor configured to measure a temperature of the furnace; and a controller configured to control the flow controller based on a difference between the temperature of the furnace and a preset temperature.

The controller may include: a temperature storage unit configured to store the preset temperature; a temperature comparison unit configured to calculate the difference between the temperature of the furnace and the preset temperature; and a temperature compensation unit configured to increase or decrease the flow rate of the cooling fluid through the flow controller based on the difference between the temperature of the furnace and the preset temperature.

According to still another aspect of an embodiment of the present invention, there is provided a deposition apparatus including a deposition source including a furnace extending in a first direction, the furnace being configured to discharge deposits deposited on a substrate; a cooling housing on the furnace comprising a plurality of cooling plates, wherein each of the cooling plates includes a plurality of cooling flow paths symmetrically formed about a center portion of the furnace; and a substrate holder opposite the deposition source, wherein the substrate is positioned on the substrate holder.

The deposition source or the substrate holder may form a thin film on the substrate while moving in a second direction perpendicular to the first direction and parallel to a plane of the substrate.

A cooling fluid supply portion may be configured to supply cooling fluid to the cooling flow paths.

Cooling fluid may flow through the cooling flow paths, and a flow controller may be coupled to each of the cooling flow paths to control a flow rate of the cooling fluid.

The deposition source may further include a temperature sensor configured to measure a temperature of the furnace; and a controller configured to control the flow controller based on a difference between the temperature of the furnace and a preset temperature.

The controller may include: a temperature storage unit configured to store the preset temperature; a temperature comparison unit configured to calculate the difference between the temperature of the furnace and the preset temperature; and a temperature compensation unit configured to increase or decrease the flow rate of the cooling fluid through the flow controller based on the difference between the temperature of the furnace and the preset temperature.

According to embodiments of the present invention, at least the following effects can be achieved.

That is, even if the length of the deposition source is increased, the temperature deviation depending on the positions in the deposition source may be minimized, and thus the thickness of the thin film formed by the deposition source may be more uniform.

Further, because the temperatures at various locations within the deposition source are measured in real time in the deposition process and the temperature control is automatically performed based on the measured temperatures, wastes of time and cost can be reduced.

The effects according to embodiments of the present invention are not limited to the contents as exemplified above, but more various effects are described in the specification of the present invention.

### BRIEF DESCRIPTION OF THE DRAWINGS

The above and other features and aspects of the embodiments of the present invention will be more apparent from the following detailed description taken in conjunction with the accompanying drawings, in which:

FIG. 1 is a schematic view illustrating a deposition apparatus according to an embodiment of the present invention;

FIG. 2 is a schematic perspective view illustrating a deposition source according to an embodiment of the present invention;

FIG. 3 is a schematic cross-sectional view taken along line III-III′ in FIG. 2;

FIG. 4 is a block diagram illustrating the configuration of a controller of a deposition source according to an embodiment of the present invention;

FIG. 5 is a schematic front view illustrating one of a plurality of cooling plates included in a cooling housing of a deposition source according to an embodiment of the present invention;

FIG. 6 is a schematic front view illustrating one of a plurality of cooling plates included in a cooling housing of a deposition source according to another embodiment of the present invention; and

FIG. 7 is a schematic front view illustrating one of a plurality of cooling plates included in a cooling housing of a deposition source according to still another embodiment of the present invention.

### DETAILED DESCRIPTION OF THE EMBODIMENTS

The aspects and features of the embodiments of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention.

The term “on” that is used to designate that an element is on another element or located on a different layer or a layer includes both a case where an element is located directly on another element or a layer and a case where an element is located on another element via another layer or still another element. In the entire description of exemplary embodiments of the present invention, the same drawing reference numerals are used for the same elements across various figures.

Although the terms “first, second, and so forth” are used to describe diverse constituent elements, such constituent elements are not limited by the terms. The terms are used only to discriminate a constituent element from other constituent elements. Accordingly, in the following description, a first constituent element may be a second constituent element.

Hereinafter, exemplary embodiments of the present invention will be described in detail with reference to the accompanying drawings.

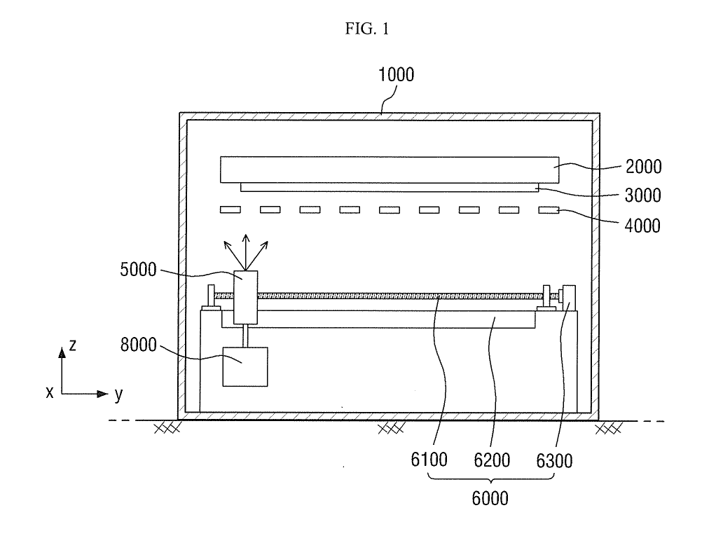

FIG. 1 is a schematic view illustrating a deposition apparatus according to an embodiment of the present invention. Referring to FIG. 1, a deposition apparatus according to an embodiment of the present invention includes a deposition source 5000 and a substrate holder 2000. The deposition apparatus according to an embodiment of the present invention may further include a deposition chamber 1000, a mask assembly 4000, a transport portion 6000, and a cooling fluid supply portion 8000.

The deposition apparatus may be an apparatus that is used in a process of manufacturing a display device, semiconductor, or solar cells. In an exemplary embodiment, the deposition apparatus may be an apparatus that forms a thin film on a substrate 3000 by performing a vapor deposition process, but is not limited thereto.

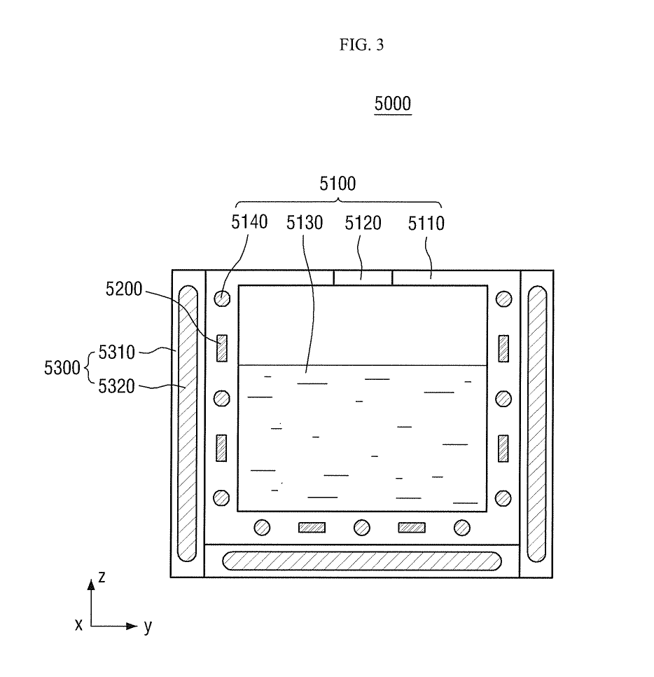

The deposition source 5000 may heat deposits 5130 (shown in FIG. 3) contained in the deposition source 5000 and discharge the deposits 5130 in gas state. The discharged deposits 5130 may be solidified on the substrate 3000 to form a thin film. The deposition source 5000 may include a furnace 5100 and a cooling housing 5300. The deposition source 5000 may be formed to extend in a first direction, and here, the first direction may be a length direction of the deposition source 5000. In an exemplary embodiment illustrated in FIG. 1, the first direction may be an x-direction. The details of the deposition source 5000 will be described later.

The substrate holder 2000 may be positioned within the deposition chamber 1000 such that the substrate 3000 faces the deposition source 5000. The substrate holder 2000 may fix or secure the substrate 3000 onto the substrate holder 2000. The substrate holder 2000 may secure the substrate 3000 to the surface of the substrate holder 2000 facing the deposition source 5000 using a fixing means (not illustrated), such as a fixing clip or an adsorption plate.

The deposition chamber 1000 may provide a space for performing a deposition process. The pressure of the inside of the deposition chamber 1000 may be kept close to a vacuum state using a vacuum pump (not illustrated). The deposition source 5000 may be positioned on a lower side of the deposition chamber 1000 and the substrate holder 2000 may be positioned on an upper side of the deposition chamber 1000. However, embodiments of the present invention are not limited thereto, and the positions thereof may be changed. The deposition chamber 1000 may further include a port (not illustrated) for placing the substrate 3000 in the deposition chamber 1000 or removing the substrate 3000 from the deposition chamber 1000. The deposition chamber 1000 may further include an exhaust end (not illustrated) for controlling the pressure inside of the deposition chamber 1000 and for exhausting the deposits 5130 that are not deposited on the substrate 3000.

The mask assembly 4000 may be positioned between the substrate holder 2000 and the deposition source 5000. The mask assembly 4000 may include a plurality of openings formed in a pattern (e.g., a predetermined pattern). The mask assembly 4000 may cause the deposits 5130 discharged from the deposition source 5000 to pass through the plurality of openings and be deposited on the substrate 3000 according to the pattern (e.g., the predetermined pattern).

The transport portion 6000 may be coupled to the deposition source 5000 or the substrate holder 2000. The transport portion 6000 may transport the deposition source 5000 or the substrate holder 2000 in a constant direction. In an exemplary embodiment illustrated in FIG. 1, the transport portion 6000 may be coupled to the deposition source 5000 to transport the deposition source 5000 in a direction, which is substantially perpendicular to the length direction of the deposition source 5000 and is substantially parallel to the substrate 3000, that is, in the y-direction. However, embodiments of the present invention are not limited thereto. For example, the transport portion 6000 may be coupled to the substrate holder 2000 and the substrate holder 2000 may be transported in the negative y-direction.

The transport portion 6000 may include a ball screw 6100, a guide 6200, and a motor 6300. The ball screw 6100 may be coupled (e.g., directly connected) to the deposition source 5000 and may be rotated to cause the deposition source 5000 to be transported laterally in the y-direction, substantially perpendicular to the length direction of the deposition source 5000. Additionally, by periodically changing the rotating direction of the ball screw 6100, the deposition source 5000 may be transported laterally back and forth along the y-axis. In an exemplary embodiment illustrated in FIG. 1, the deposition source 5000 may perform a reciprocating motion in the y-direction or in the negative y-direction. The guide 6200 may be positioned on the lower side of the deposition source 5000 to control the alignment and movement direction of the deposition source 5000. That is, the guide 6200 may prevent the deposition source 5000 from being tilted or seceding from the moving direction. The motor 6300 may provide a driving force to rotate the ball screw 6100.

The cooling fluid supply portion 8000 may be positioned on the lower side of the deposition source 5000. The cooling fluid supply portion 8000 may store cooling fluid and supply the cooling fluid to the cooling housing 5300, specifically, a cooling flow path 5320 to be described later. Here, the cooling fluid may be cooling water, but is not limited thereto. The cooling fluid may be cooling gas, such as nitrogen, helium, hydrogen, or a combination thereof. The cooling fluid supply portion 8000 may be coupled to an outside of the deposition chamber 1000 to continuously provide a supply of the cooling fluid to the deposition chamber 1000 from the outside. The temperature of the cooling fluid that is stored in the cooling fluid supply portion 8000 may be controlled in advance from the outside, but is not limited thereto. The cooling fluid supply portion 8000 may be provided with a separate temperature controller. In an exemplary embodiment, the cooling fluid supply portion 8000 may include one storage chamber in which cooling fluid with constant temperature is stored. Accordingly, the cooling fluid that is supplied to the cooling housing 5300 may have a constant or substantially constant temperature. In another exemplary embodiment, the cooling fluid supply portion 8000 may include a plurality of storage chambers for storing cooling fluids with different temperatures, respectively. Accordingly, the temperatures of the cooling fluids supplied to the cooling housing 5300 may differ depending on the positions in the deposition source 5000, and the temperatures of the cooling fluids being supplied may be controlled depending on the positions in the deposition source 5000.

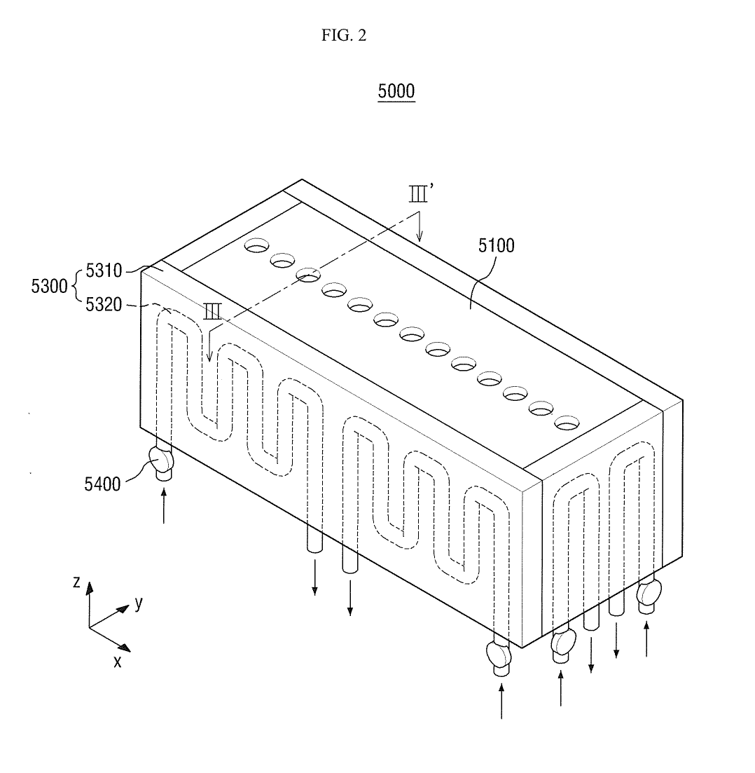

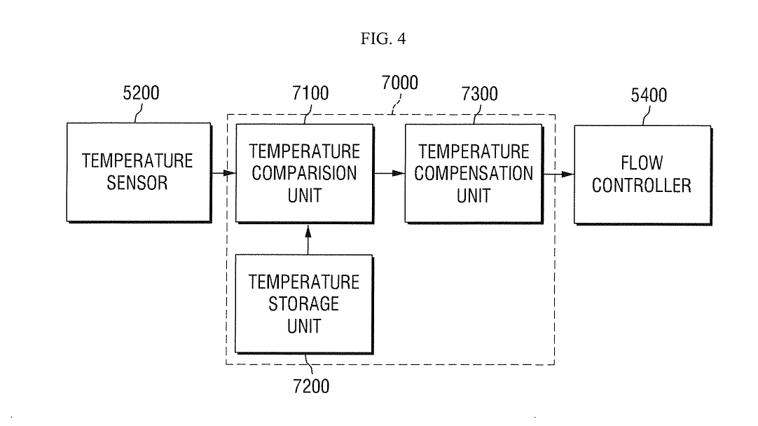

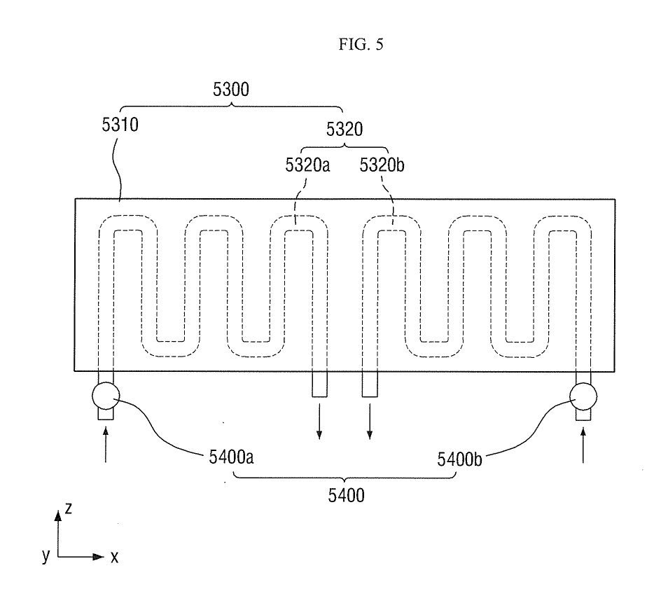

Hereinafter, the deposition source 5000 according to an embodiment of the present invention will be described with reference to FIGS. 2 to 5. FIG. 2 is a schematic perspective view illustrating a deposition source 5000 according to an embodiment of the present invention, and FIG. 3 is a schematic cross-sectional view taken along line III-III′ in FIG. 2. FIG. 4 is a block diagram illustrating the configuration of a controller 7000 of a deposition source 5000 according to an embodiment of the present invention. FIG. 5 is a schematic front view illustrating one of a plurality of cooling plates 5310 included in a cooling housing 5300 of a deposition source 5000 according to an embodiment of the present invention. For convenience in explanation, the same reference numerals are used for elements that are substantially the same as the elements illustrated in FIG. 1, and the duplicate explanation thereof will be omitted.

The deposition source 5000 according to an embodiment of the present invention includes the furnace 5100 and the cooling housing 5300. The deposition source 5000 according to an embodiment of the present invention may further include a flow controller 5400, a temperature sensor 5200, and a controller 7000.

The furnace 5100 may be formed, for example, in a cuboidal shape, and may include a space therein. The inner space of the furnace 5100 may be surrounded by a furnace housing 5110. In the inner space of the furnace 5100, deposits 5130 in solid state or in liquid state may be contained. Here, the deposits 5130 may be organic materials, but are not limited thereto. The deposits 5130 may be sublimated or evaporated by being heated by a heater 5140 located within the furnace housing 5110, and may be discharged to the outside of the furnace 5100 through a discharge port 5120. Here, the heater 5140, which may be a heating means, such as a heating coil, may convert electric energy received from the outside into thermal energy and transfer heat to the deposits 5130 inside the furnace 5100. Referring to FIG. 3, the heater 5140 may be formed to be spaced apart for a predetermined distance in the furnace housing 5110. The deposits 5130 discharged to the outside of the furnace 5100 may be deposited on the substrate 3000 to form a thin film.

The furnace 5100 may be formed to extend in the first direction. Here, the first direction may be defined as a length direction of the furnace 5100. In an exemplary embodiment illustrated in FIG. 2, the first direction may be an x-direction. Because the furnace 5100 extends in the first direction, the furnace 51 may include a plurality of discharge ports 5120, and the plurality of discharge ports 5120 may be arranged in the first direction. In an exemplary embodiment illustrated in FIG. 2, the plurality of discharge ports 5120 are arranged in a line. However, embodiments of the present invention are not limited thereto, but the plurality of discharge ports 5120 may be arranged, for example, in a plurality of columns or in a matrix form.

As illustrated in FIG. 2, the furnace 5100 may include one inner space formed therein. However, the furnace 5100 may also include a plurality of inner spaces. In an exemplary embodiment, a plurality of furnaces 5100 may be arranged in a direction which is perpendicular to the length direction of the furnaces 5100 and is parallel to the substrate 3000, that is, in the y-direction. Further, the plurality of furnaces 5100 may be integrally formed as one furnace 5100. In this case, the cooling housing 5300 may be interposed between the plurality of inner spaces.

The cooling housing 5300 may be formed on the furnace 5100. In an exemplary embodiment, the cooling housing 5300 may be formed to be in contact with the furnace housing 5110. In an exemplary embodiment illustrated in FIGS. 2 and 3, the cooling housing 5300 may surround all surfaces of the furnace 5100 except for one surface of the furnace 5100 on which the discharge port 5120 is formed. In another exemplary embodiment, the cooling housing 5300 may surround the furnace 5100, but expose the discharge port 5120. In another exemplary embodiment, the cooling housing 5300 may be integrally formed with the furnace housing 5110.

The cooling housing 5300 may include a plurality of cooling plates 5310. Each of the cooling plates 5310 may correspond to one surface of the furnace 5100. That is, each of the cooling plates 5310 may come in contact with one surface of the furnace 5100 to absorb heat emitted from the furnace 5100. In an exemplary embodiment illustrated in FIGS. 2 and 3, five cooling plates 5310 may be provided in total: two on opposing long side surfaces (corresponding to x-z plane) of the furnace 5100, two on opposing short side surfaces (corresponding to y-z plane) thereof, and one on the bottom surface (corresponding to x-y plane). In another exemplary embodiment, that is, in an embodiment in which three of the furnaces 5100 illustrated in FIG. 2 are arranged in the direction which is perpendicular to the length direction of the furnace 5100 and is parallel to the substrate 3000, that is, in the y direction, seven cooling plates 5310 may be provided in total: two on opposing long side surfaces of the two outside furnaces 5100, two on opposing short side surfaces of the three furnaces 5100, one on the bottom surface of the three furnaces 5100, and two between each of the adjacent furnaces 5100. In still another exemplary embodiment, two or more cooling plates 5310 may be provided on one surface of the furnace 5100.

The cooling plate 5310 may include a cooling flow path 5320. The cooling flow path 5320 may be formed on the inside of the cooling plate 5310 in a pipe form. The cooling flow path 5320 may receive the cooling fluid from the cooling fluid supply portion 8000 and the deposition source 5000 may substantially perform the cooling function. In an exemplary embodiment, because the furnace 5100 is heated at 300° C. to 450° C. and the cooling fluid has a temperature that is the ambient temperature, for example, 25° C., or a temperature that is lower than the ambient temperature, a region of the furnace 5100 that corresponds to a region on which the cooling flow path 5320 is formed may be cooled through heat transfer from high temperature to low temperature. In order to widen the region on which the cooling flow path 5320 is formed, that is, in order to heighten the cooling efficiency of the cooling plate 5310, the cooling flow path 5320 may be formed to be bent several times (e.g., in a zigzag pattern).

Each of the plurality of cooling plates 5310 may include a plurality of cooling flow paths 5320. In an exemplary embodiment illustrated in FIGS. 2 and 5, one cooling plate 5310 may include two cooling flow paths 5320. The plurality of cooling flow paths 5320 formed on the plurality of cooling plates 5310 may be symmetrically formed about a center portion of the furnace 5100. Here, the center portion of the furnace 5100 may mean the center portion of the furnace housing 5110. Further, “symmetrical about the center portion of the furnace 5100” may mean symmetrical about the center portion of the cooling plate 5310 that corresponds to the center portion of the furnace 5100. In an exemplary embodiment illustrated in FIG. 2, on the cooling plate 5310 on the long side surface of the furnace 5100 as seen from the front, the cooling flow paths 5320 may be bilaterally symmetric about the center portion of the cooling plate 5310 that corresponds to the center portion of the furnace 5100, that is, the center portion of the cooling plate 5310 that corresponds to a point that corresponds to a half of the length of the furnace 5100.

If one cooling plate 5310 includes a plurality of cooling flow paths 5320 as described above, the length of the cooling flow path 5320, that is, the length between the supply port and the discharge port, is reduced, and thus the temperature increase of the cooling fluid due to the heat discharged from the furnace 5100 can be suppressed. Accordingly, by reducing the temperature difference of the cooling fluid between the supply port and the discharge port of the cooling flow path 5320, the temperatures depending on the positions in the deposition source 5000 can be uniformly controlled. Further, by individually controlling the plurality of symmetrically formed cooling flow paths 5320, the temperature in the length direction or width direction of the deposition source 5000 can be uniformly controlled. Here, one method for individually controlling the plurality of cooling flow paths 5320 may be, as described above, a method for supplying the cooling fluids having different temperatures through the cooling fluid supply portion 8000 depending on the positions in the deposition source 5000. That is, the temperatures depending on the positions in the deposition source 5000 can be uniformly controlled in a manner that the cooling fluid having a relatively low temperature is supplied to a portion of the deposition source 5000 having a relatively high temperature while the cooling fluid having a relatively high temperature is supplied to a portion of the deposition source 5000 having a relative low temperature or the supply of the cooling fluid is temporarily interrupted in the deposition source 5000.

Another method for individually controlling the plurality of cooling flow paths 5320 may be a method for controlling the positions of the supply ports and the discharge ports of the cooling flow paths 5320. The details thereof will be described later. Still another method for individually controlling the plurality of cooling flow paths 5320 may be a method for controlling the flow rates of the cooling fluids flowing to the cooling flow paths 5320 through the flow controllers 5400 installed on the cooling flow paths 5320. The details thereof will be described later.

Each of the plurality of cooling flow paths 5320 may include at least one supply port through which the cooling fluid is supplied and at least one discharge port through which the cooling fluid is discharged. In an exemplary embodiment, the supply ports may be positioned at both ends of the cooling plate 5310, and the discharge ports may be positioned in the center portion of the cooling plate 5310. In another exemplary embodiment, the discharge port may be positioned between the supply ports. In an exemplary embodiment illustrated in FIGS. 2 and 5, the supply portion and the discharge portion are indicated by directions of arrows. That is, if the arrow is in the direction of the cooling flow path 5320, the corresponding portion is the supply port, and if the arrow is in the opposite direction to the cooling flow path 5320, the corresponding portion is the discharge port.

The temperature of both end portions of the deposition source 5000 may be relatively higher than the temperature of the center portion thereof. Accordingly, if the cooling fluid is supplied to the both ends of the cooling plate 5310 that correspond to the both ends of the deposition source 5000 and is discharged from the center portion of the cooling plate 5310 that corresponds to the center portion of the deposition source 5000, the temperature of the cooling fluid at both ends of the cooling plate 5310 may be lower than the temperature of the cooling fluid in the center portion of the cooling plate 5310 that receives the heat emitted from the furnace 5100. Accordingly, the thermal balance of the deposition source 5000 can be improved or satisfied, and thus the temperatures depending on the positions in the deposition source 5000 can be substantially uniformly controlled.

If the temperature of the center portion of the deposition source 5000 is relatively higher than the temperature of the both ends thereof, the supply port of the cooling flow path 5320 may be positioned in the center portion of the cooling plate 5310, and the discharge port thereof may be positioned at both ends of the cooling plate 5310. As described above, by controlling the positions of the supply port and the discharge port of the cooling flow path 5320 depending on the temperature difference due to the positions thereof in the deposition source 5000, the temperatures depending on the positions in the deposition source 500 can be substantially uniformly controlled.

The flow controller 5400 may be installed in the cooling flow path 5320. The flow controller 5400 may control the flow rate of the cooling fluid that flows through the cooling flow path 5320. In an exemplary embodiment, the flow controller 5400 may be installed on the supply port and/or the discharge port of the cooling flow path 5320. In another exemplary embodiment, the flow controller 5400 may be installed inside the cooling plate 5310. In still another exemplary embodiment, the flow controller 5400 may be installed on the cooling fluid supply portion 8000.

The temperature sensor 5200 may be installed in the furnace housing 5110 or on the furnace housing 5110. The temperature sensor 5200 may measure the temperature of the furnace 5100. A plurality of temperature sensors 5200 may be provided, and may be in the form of a point, line, or surface. If the plurality of temperature sensors 5200 is provided, they may measure temperatures at various positions within the deposition source 5000. In an exemplary embodiment illustrated in FIG. 3, the temperature sensors 5200 may be positioned between the heaters 5140, but embodiments of the present invention are not limited thereto.

The controller 7000 may control the flow controller 5400 to correspond to the difference between the temperature measured by the temperature sensor 5200 and a preset temperature. For the detailed explanation thereof, referring to FIG. 4, the controller 7000 may include a temperature storage unit 7200, a temperature comparison unit 7100, and a temperature compensation unit 7300.

The temperature storage unit 7200 stores preset temperatures depending on the positions in the deposition source 5000, and the preset temperatures are provided to the temperature comparison unit 7100. Here, the preset temperatures may be equal to one another regardless of the position of the deposition source 5000. However, embodiments of the present invention are not limited thereto, but the preset temperatures may differ depending on the position of the deposition source 5000.

The temperature comparison unit 7100 may receive the temperatures measured depending on the positions in the deposition source 5000 from the temperature sensor 5200, and may receive the preset temperatures depending on the positions in the deposition source 5000 from the temperature storage unit 7200. The temperature comparison unit 7100 may calculate the temperature difference value by comparing the measured temperature with the preset temperature in the same position. In an exemplary embodiment of the present invention, the temperature comparison unit 7100 may calculate the value that is obtained by subtracting the preset temperature from the measured temperature. The temperature difference value calculated by the temperature comparison unit 7100 may be provided to the temperature compensation unit 7300.

The temperature compensation unit 7300 may control the flow controller 5400 in the position corresponding to the difference value based on the difference value provided from the temperature comparison unit 7100. Here, the position that corresponds to the difference value may be the position that corresponds to the measured temperature and the preset temperature which are used when the difference value is calculated. In an exemplary embodiment, if the difference value corresponds to a positive number, it means that the measured temperature is higher than the preset temperature, and thus the cooling efficiency can be increased or improved by increasing the flow rate of the cooling fluid that passes through the cooling flow path 5320 through control of the flow controller 5400. In this case, as the absolute value of the difference value becomes larger, the flow rate of the cooling fluid is further increased. In another exemplary embodiment, if the difference value corresponds to a negative number, it means that the measured temperature is lower than the preset temperature, and thus the cooling efficiency can be lowered by decreasing the flow rate of the cooling fluid that passes through the cooling flow path 5320 through control of the flow controller 5400. In this case, as the absolute value of the difference value becomes larger, the flow rate of the cooling fluid is further decreased. Because the above-described contents have been described on the assumption that as the flow rate of the cooling fluid is increased, the cooling efficiency is increased, it may be possible to select and apply the flow rate of the cooling fluid that matches the actual processing condition.

The detailed example of the above-described contents will be described with reference to FIG. 5. The cooling plate 5310 of the cooling housing 5300 in FIG. 5 includes two cooling flow paths 5320, that is, a first cooling flow path 5320a and a second cooling flow path 5320b, and the flow controller 5400 may be installed in each of the cooling flow paths 5320. That is, a first flow controller 5400a may be installed on the supply port of the first cooling flow path 5320a, and a second flow controller 5400b may be installed on the supply port of the second cooling flow path 5320b. Here, if it is assumed that the temperature at both ends of the deposition source 5000 is higher than the temperature in the center portion of the deposition source 5000, for example, if the temperature at the left end portion of the deposition source 5000 is higher than the temperature at the right end portion of the deposition source 5000, the controller 7000 may control the first flow controller 5400a to make the flow rate of the cooling fluid passing through the first cooling flow path 5320a become higher than the flow rate of the cooling fluid passing through the second cooling flow path 5320b. Accordingly, the cooling of the left end portion of the deposition source 5000 can be performed more efficiently than the cooling of the right end portion of the deposition source 5000, and thus the temperature at the left end portion of the deposition source 5000 becomes similar to the temperature at the right end portion of the deposition source 5000. Further, because the temperature of the cooling fluid that flows at both ends of the deposition source 5000 is lower than the temperature of the cooling fluid that flows in the center portion of the deposition source 5000, the cooling of the both ends of the deposition source 5000 can be performed more efficiently than the cooling of the center portion of the deposition source 5000, and thus the temperature at the both ends of the deposition source 5000 becomes similar to the temperature in the center of the deposition source 5000. Accordingly, the temperature at various positions of the deposition source 5000 can be substantially uniformly controlled.

As described above, in addition to the controlling of the flow controller 5400 based on measurements of the temperatures of the deposition source 5000 at various positions in the deposition source 5000, the controller 7000 may also control the temperature of the cooling fluid that is supplied from the cooling fluid supply portion 8000 based on measurements of the temperatures of the deposition source 5000 at various positions in the deposition source 5000, or may control the positions of the supply port and the discharge port of the cooling flow path 5320 based on measurements of the temperatures of the deposition source 5000 at various positions in the deposition source 5000. Accordingly, the temperatures at various positions in the deposition source 5000 can be substantially uniformly maintained.

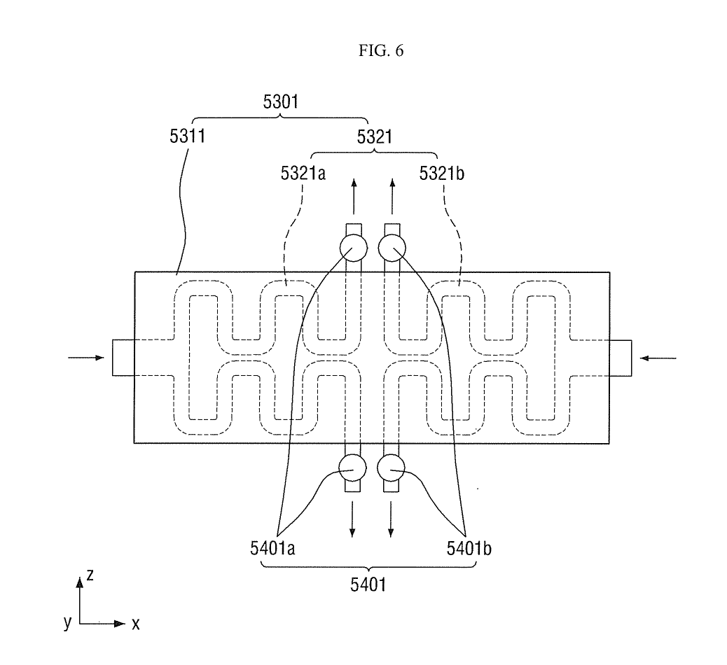

FIG. 6 is a schematic front view illustrating one of a plurality of cooling plates 5311 included in a cooling housing 5301 of a deposition source (e.g., deposition source 5000) according to another embodiment of the present invention. For convenience in explanation, the same reference numerals are used for elements that are substantially the same as the elements as illustrated in FIG. 5, and the duplicate explanation thereof will be omitted.

Referring to FIG. 6, each of the plurality of cooling flow paths 5321 included in the cooling plate 5311 of the cooling housing 5301 may include a plurality of discharge ports corresponding to one supply port, and the flow controller 5401 may be installed on each of the plurality of discharge ports. In another exemplary embodiment, each of the plurality of cooling flow paths 5321 may include a plurality of supply ports corresponding to one discharge port, and the flow controller 5401 may be installed on each of the plurality of supply ports.

In an exemplary embodiment illustrated in FIG. 6, a supply port of the first cooling flow path 5321a may be positioned on the left side surface of the cooling plate 5311, two discharge ports may be positioned on the upper surface and the lower surface of the cooling plate 5311, a supply port of the second cooling flow path 5321b may be positioned on the right side surface of the cooling plate 5311, and two discharge ports may be positioned on the upper surface and the lower surface of the cooling plate 5311. Further, first flow controllers 5401a may be installed on or coupled to the two discharge ports of the first cooling flow path 5321a, and second flow controllers 5401b may be installed on or coupled to the two discharge ports of the second cooling flow path 5321b. As described above, the first cooling flow path 5321a may individually control the temperatures of upper and lower divided portions on the left side of the cooling plate 5311, and the second cooling flow path 5321b may individually control the temperatures of upper and lower divided portions on the right side of the cooling plate 5311. Accordingly, the first cooling flow path 5321a and the second cooling flow path 5321b may individually control the temperatures of the deposition sources corresponding to the respective regions by dividing the cooling plate 5311 into four portions in total.

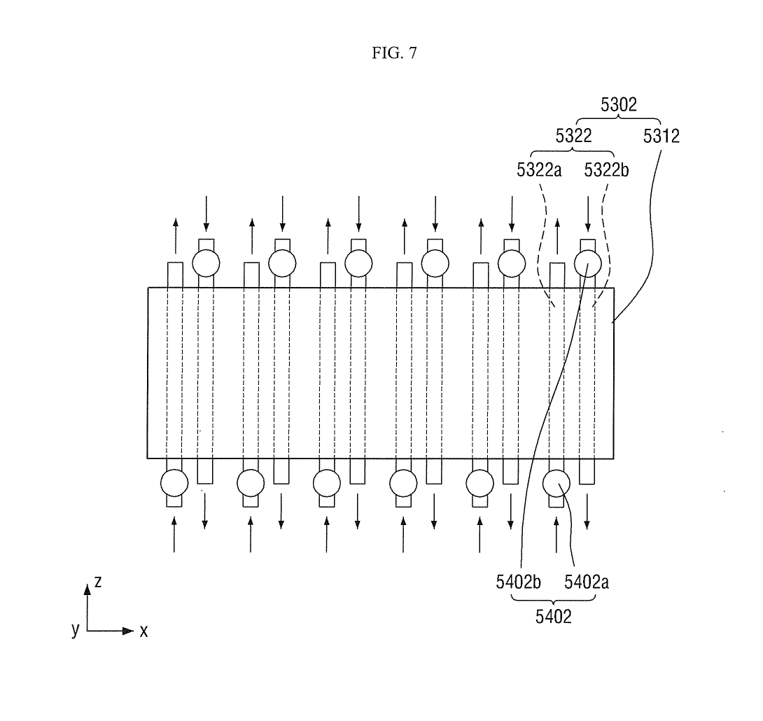

FIG. 7 is a schematic front view illustrating one of a plurality of cooling plates 5312 included in a cooling housing 5302 of a deposition source (e.g., deposition source 5000) according to still another embodiment of the present invention. For convenience in explanation, the same reference numerals are used for elements that are substantially the same as the elements as illustrated in FIG. 5, and the duplicate explanation thereof will be omitted.

Referring to FIG. 7, a plurality of cooling flow paths 5322 included in the cooling plate 5312 of the cooling housing 5302 may include a plurality of first cooling flow paths 5322a arranged to be spaced apart from each other and second cooling flow paths 5322b arranged adjacent to the respective first cooling flow paths 5322a. Specifically, the first cooling flow paths 5322a and the second cooling flow paths 5322b may be alternately arranged. Further, the first cooling flow paths 5322a and the second cooling flow paths 5322b may make the cooling fluid flow in opposite directions to each other through the first and second cooling flow paths. Further, flow controllers 5402 may be installed on or coupled to the first cooling flow paths 5322a and the second cooling flow paths 5322b. That is, first flow controllers 5402a may be installed on or coupled to the supply ports of the first cooling flow paths 5322a, and second flow controllers 5402b may be installed on or coupled to the supply ports of the second cooling flow paths 5322b. As described above, by alternately arranging the first cooling flow paths 5322a and the second cooling flow paths 5322b and making the cooling fluid flow in opposite directions to each other through the first cooling flow paths 5322a and the second cooling flow paths 5322b, it becomes easier to uniformly control the temperatures depending on the positions in the deposition source.

While the present invention has been particularly shown and described with reference to exemplary embodiments thereof, it will be understood by those of ordinary skill in the art that various changes in form and details may be made therein without departing from the spirit and scope of the present invention as defined by the following claims. It is therefore desired that the present embodiments be considered in all respects as illustrative and not restrictive, reference being made to the appended claims and their equivalents, rather than the foregoing description, to indicate the scope of the invention.

What is claimed is:

1. A deposition source comprising:
a furnace extending in a first direction and configured to discharge deposits on a substrate; and
a cooling housing on the furnace comprising a plurality of cooling plates,
wherein each of the cooling plates comprises a plurality of cooling flow paths around the furnace.

2. The deposition source of claim 1, wherein cooling fluid is supplied from opposing ends of each of the cooling plates through the cooling flow paths, and the cooling fluid is discharged from a center portion of each of the cooling plates.

3. The deposition source of claim 2, wherein each of the cooling flow paths comprises a supply port configured to supply the cooling fluid and a discharge port configured to discharge the cooling fluid.

4. The deposition source of claim 2, wherein each of the cooling flow paths comprises a plurality of discharge ports corresponding to a supply port, and flow controllers coupled to the discharge ports, respectively, to control a flow rate of the cooling fluid, or
comprises a plurality of supply ports corresponding to a discharge port, and flow controllers coupled to the supply ports, respectively, to control the flow rate of the cooling fluid.

5. The deposition source of claim 1, wherein the furnace comprises a plurality of discharge ports arranged along the first direction, and
the cooling housing on sides of the furnace with the plurality of discharge ports exposed.

6. The deposition source of claim 1, wherein the cooling fluid flows through the cooling flow paths, and
a flow controller is coupled to each of the cooling flow paths to control a flow rate of the cooling fluid.

7. The deposition source of claim 6, further comprising:
a temperature sensor configured to measure a temperature of the furnace; and
a controller configured to control the flow controller based on a difference between the temperature of the furnace and a preset temperature.

8. The deposition source of claim 7, wherein the controller comprises:
a temperature storage unit configured to store the preset temperature;
a temperature comparison unit configured to calculate the difference between the temperature of the furnace and the preset temperature; and
a temperature compensation unit configured to increase or decrease the flow rate of the cooling fluid through the flow controller based on the difference between the temperature of the furnace and the preset temperature.

9. A deposition source comprising:
a furnace extending in a first direction and configured to discharge deposits on a substrate; and
a cooling housing on the furnace comprising a plurality of cooling plates,
wherein each of the cooling plates comprises a plurality of cooling flow paths through which cooling fluid flows, and
at least one flow controller coupled to each of the cooling flow paths to control a flow rate of the cooling fluid.

10. The deposition source of claim 9, wherein each of the cooling flow paths is around the furnace.

11. The deposition source of claim 10, wherein the cooling fluid is supplied from opposing ends of each of the cooling plates through the cooling flow paths, and the cooling fluid is discharged from a center portion of each of the cooling plates.

12. The deposition source of claim 9, wherein the plurality of cooling flow paths comprise a plurality of first cooling flow paths spaced apart from one another and second cooling flow paths adjacent to the respective first cooling flow paths, and
the cooling fluid flows in substantially opposite directions through the first and second cooling flow paths, respectively.

13. The deposition source of claim 9, further comprising:
a temperature sensor configured to measure a temperature of the furnace; and
a controller configured to control the flow controller based on a difference between the temperature of the furnace and a preset temperature.

14. The deposition source of claim 13, wherein the controller comprises:
a temperature storage unit configured to store the preset temperature;
a temperature comparison unit configured to calculate the difference between the temperature of the furnace and the preset temperature; and
a temperature compensation unit configured to increase or decrease the flow rate of the cooling fluid through the flow controller based on the difference between the temperature of the furnace and the preset temperature.

15. A deposition apparatus comprising:
a deposition source comprising a furnace extending in a first direction, the furnace being configured to discharge deposits on a substrate;
a cooling housing on the furnace comprising a plurality of cooling plates, wherein each of the cooling plates comprises a plurality of cooling flow paths around the furnace; and
a substrate holder opposite the deposition source, wherein the substrate is positioned on the substrate holder.

16. The deposition apparatus of claim 15, wherein the deposition source or the substrate holder forms a thin film on the substrate while moving in a second direction perpendicular to the first direction and parallel to a plane of the substrate.

17. The deposition apparatus of claim 15, further comprising a cooling fluid supply portion configured to supply cooling fluid to the cooling flow paths.

18. The deposition apparatus of claim 15, wherein cooling fluid flows through the cooling flow paths, and
a flow controller is coupled to each of the cooling flow paths to control a flow rate of the cooling fluid.

19. The deposition apparatus of claim 18, wherein the deposition source further comprises:
a temperature sensor configured to measure a temperature of the furnace; and
a controller configured to control the flow controller based on a difference between the temperature of the furnace and a preset temperature.

20. The deposition apparatus of claim 19, wherein the controller comprises:
a temperature storage unit configured to store the preset temperature;
a temperature comparison unit configured to calculate the difference between the temperature of the furnace and the preset temperature; and
a temperature compensation unit configured to increase or decrease the flow rate of the cooling fluid through the flow controller based on the difference between the temperature of the furnace and the preset temperature.
